(19) United States
(12) Patent Application Publication
(10) Pub. No.: US 2017/0177424 A1
(43) Pub. Date: Jun. 22, 2017

(54) SPECIFIC RISK TOOLKIT

(71) Applicant: BOMBARDIER INC., Dorval (CA)

(72) Inventor: Sebastien GUAY, Terrebonne (CA)

(21) Appl. No.: 15/129,628

(22) PCT Filed: Mar. 30, 2015
(86) PCT No.: PCT/IB2015/052337

§ 371 Date: Sep. 27, 2016

Related U.S. Application Data
(60) Provisional application No. 61/972,661, filed on Mar. 31, 2014.

(51) Int. Cl. G06F 11/07; G06F 11/00

(52) U.S. Cl. CPC G06F 11/0706; G06F 11/008; G06F 11/0751; G06F 11/0766

(57) ABSTRACT

A system includes a processor and a memory system in communication with the processor. The memory system stores instructions that when executed by the processor result in the system being operable to access an event list that defines a plurality of events and a scenario list that defines a plurality of scenarios as routes through a tree structure that includes one or more of the events for each of the scenarios. The system is also operable to build a specific risk matrix that calculates a plurality of combined probabilities based on each pairing of an occurrence of each of the events in combination with each of the scenarios. The system is further operable to output a residual probability for each of the events based on a summation of the combined probabilities for each of the events.

### CROSS-REFERENCE TO RELATED APPLICATION

This International PCT Patent Application relies for priority on U.S. Provisional Patent Application Ser. No. 61/972,661 filed on Mar. 31, 2014, the entire content of which is incorporated herein by reference.

### FIELD OF THE INVENTION

The present invention relates in general to risk analysis systems, and in particular to a specific risk toolkit that calculates combined probabilities of event occurrences and scenarios of events to determine residual probability values per event.

### BACKGROUND OF THE INVENTION

In complex systems, as part of a safety assessment or fault analysis process, fault trees are typically developed to define a top-down system fault definition. A fault tree can be developed for a system by decomposing each top-level system failure condition into a number of possible contributing failure conditions based on events. For example, a basic event models a failure or error in a system component. An external event models an expected event that is not a fault. An undeveloped event is an event where insufficient information is available or is inconsequential. Other types of events can also be defined. Logic gates can be used to describe relationships between various events and system components. For example, an OR gate indicates that an output occurs if any input to the OR gate occurs, while an AND gate indicates that an output occurs only if all inputs to the AND gate occur. Other types of logic gates can also be defined.

Fault tree analysis tools typically provide a graphical user interface to interconnect graphical symbols to form a graphical representation of a fault tree. Fault tree analysis tools can define a number of parameters to assist in analyzing effects of faults and other events on a system. Fault tree nodes of a fault tree can include fault probability values for each event represented in a fault tree. The fault probability values can be defined according to a specific failure type, such as an active failure, a dormant failure for a period of time, or a permanent dormant failure, for example. Fault probability values flow up through the fault tree to a top-level node that represents a top-level system condition. A user can manually set events in the fault tree and observe changes in fault probability values that propagate up through the fault tree. Some fault analysis procedures can be performed on a single event basis, where the fault tree is configured to a desired state and the fault probability value of the top-level node is observed. Other types of fault analysis procedures require changes in the state of the fault tree to be observed over a period of time for a sequence of events. After each change of state, the fault probability value of the top-level node can be observed and manually recorded. While a fault tree analysis tool can enable a user make a number of state changes to a fault tree and observe the results, performing a sequence of state changes to the fault tree and recording the results can be a labor-intensive process. A complex system can have many fault trees defined, which further increases the amount of time needed to analyze a sequence of state changes for each of the fault trees.

What is needed is an improved system and process to compute results that substantially align with a sequence of state changes to a fault tree, while reducing the amount of time needed to calculate and output the results over manually making each state change using a fault tree analysis tool.

### SUMMARY OF THE INVENTION

According to an embodiment of the present invention, a system includes a processor and a memory system in communication with the processor. The memory system stores instructions that when executed by the processor result in the system being operable to access an event list that defines a plurality of events and a scenario list that defines a plurality of scenarios as routes through a tree structure that includes one or more of the events for each of the scenarios. The system is also operable to build a specific risk matrix that calculates a plurality of combined probabilities based on each pairing of an occurrence of each of the events in combination with each of the scenarios. The system is further operable to output a residual probability for each of the events based on a summation of the combined probabilities for each of the events.

In an advantageous embodiment of the present invention, the events in the event list comprise basic events, and the one or more of the events for each of the scenarios comprise a plurality of contributing events in the scenario list.

In an advantageous embodiment of the present invention, the event list further comprises basic event probabilities associated with the basic events.

In an advantageous embodiment of the present invention, the basic events and the basic event probabilities are extracted from the tree structure to populate the event list.

In an advantageous embodiment of the present invention, the specific risk matrix further comprises a plurality of contributor columns for the contributing events up to a maximum number of the contributing events defined for any one of the scenarios.

In an advantageous embodiment of the present invention, the specific risk matrix further comprises a plurality of rows for pairings of an occurrence of each of the basic events in combination with each of the scenarios.

In an advantageous embodiment of the present invention, each of a plurality of probability values for the contributor columns is populated with each of the basic event probabilities that map to each of the contributing events.

In an advantageous embodiment of the present invention, each of the probability values for unpopulated locations in the contributor columns is populated with a value of one, and each of the probability values for locations in the contributor columns that map to the occurrence of each of the basic events in each of the rows is populated with a value of one.

In an advantageous embodiment of the present invention, each of the combined probabilities is calculated as a product of each of the probability values across the contributor columns of each of the rows.

In an advantageous embodiment of the present invention, the residual probability for each of the events is output to a report that associates each of the events with an event description and the residual probability for each of the events in a sorted order from a highest residual probability to a lowest residual probability.

In an advantageous embodiment of the present invention, formatting of the report distinguishes values of the residual probability relative to one or more threshold values.

In an advantageous embodiment of the present invention, the tree structure is a fault tree developed by a fault tree analysis tool, the scenario list is a list of cutset scenarios, and the event list and the scenario list are output by the fault tree analysis tool.

In an advantageous embodiment of the present invention, the event list and the scenario list are accessed by one or more applications external to the fault tree analysis tool to build the specific risk matrix and output the residual probability for each of the events.

In an advantageous embodiment of the present invention, the event list and the scenario list are reformatted by a spreadsheet application and imported into a database application to build the specific risk matrix and output the residual probability for each of the events.

In an advantageous embodiment of the present invention, the tree structure comprises an event node for each of the events and an event probability that is based on a failure rate, an exposure time, and a probability type.

In an advantageous embodiment of the present invention, the probability type for each event node having to an average probability is changed to a worst-case probability, and the event probability is updated prior to calculation of the combined probabilities.

In an advantageous embodiment of the present invention, the tree structure is a fault tree structure for a system of an aircraft, and the exposure time is set to a maximum mission flight time for the aircraft.

According to another embodiment of the present invention, a method for specific risk assessment is disclosed. The method includes accessing an event list that defines a plurality of events and a scenario list that defines a plurality of scenarios as routes through a tree structure that includes one or more of the events for each of the scenarios. A specific risk matrix is built that calculates a plurality of combined probabilities based on each pairing of an occurrence of each of the events in combination with each of the scenarios. A residual probability is output for each of the events based on a summation of the combined probabilities for each of the events.

In an advantageous embodiment of the present invention, the events in the event list comprise basic events, and the one or more of the events for each of the scenarios comprise a plurality of contributing events in the scenario list.

In an advantageous embodiment of the present invention, the event list further comprises basic event probabilities associated with the basic events.

In an advantageous embodiment of the present invention, the basic events and the basic event probabilities are extracted from the tree structure to populate the event list.

In an advantageous embodiment of the present invention, the specific risk matrix further comprises a plurality of contributor columns for the contributing events up to a maximum number of the contributing events defined for any one of the scenarios.

In an advantageous embodiment of the present invention, the specific risk matrix further comprises a plurality of rows for pairings of an occurrence of each of the basic events in combination with each of the scenarios.

In an advantageous embodiment of the present invention, each of a plurality of probability values for the contributor columns is populated with each of the basic event probabilities that map to each of the contributing events.

In an advantageous embodiment of the present invention, each of the probability values for unpopulated locations in the contributor columns is populated with a value of one, and each of the probability values for locations in the contributor columns that map to the occurrence of each of the basic events in each of the rows is populated with a value of one.

In an advantageous embodiment of the present invention, each of the combined probabilities is calculated as a product of each of the probability values across the contributor columns of each of the rows.

In an advantageous embodiment of the present invention, the residual probability for each of the events is output to a report that associates each of the events with an event description and the residual probability for each of the events in a sorted order from a highest residual probability to a lowest residual probability.

In an advantageous embodiment of the present invention, formatting of the report distinguishes values of the residual probability relative to one or more threshold values.

In an advantageous embodiment of the present invention, the tree structure is a fault tree developed by a fault tree analysis tool, the scenario list is a list of cutset scenarios, and the event list and the scenario list are output by the fault tree analysis tool.

In an advantageous embodiment of the present invention, the event list and the scenario list are accessed by one or more applications external to the fault tree analysis tool to build the specific risk matrix and output the residual probability for each of the events.

In an advantageous embodiment of the present invention, the event list and the scenario list are reformatted by a spreadsheet application and imported into a database application to build the specific risk matrix and output the residual probability for each of the events.

In an advantageous embodiment of the present invention, the tree structure comprises an event node for each of the events and an event probability that is based on a failure rate, an exposure time, and a probability type.

In an advantageous embodiment of the present invention, the probability type for each event node having to an average probability is changed to a worst-case probability, and the event probability is updated prior to calculation of the combined probabilities.

In an advantageous embodiment of the present invention, the tree structure is a fault tree structure for a system of an aircraft, and the exposure time is set to a maximum mission flight time for the aircraft.

According to yet another embodiment of the present invention, a computer program product is disclosed for specific risk assessment. The computer program product includes a computer readable storage medium having program code embodied therewith, the program code readable/executable by a computer, processor or logic circuit to perform a method that includes accessing an event list that defines a plurality of events and a scenario list that defines a plurality of scenarios as routes through a tree structure that includes one or more of the events for each of the scenarios. A specific risk matrix is built that calculates a plurality of combined probabilities based on each pairing of an occurrence of each of the events in combination with each of the scenarios. A residual probability is output for each of the events based on a summation of the combined probabilities for each of the events.

In an advantageous embodiment of the present invention, the events in the event list comprise basic events, and the one or more of the events for each of the scenarios comprise a plurality of contributing events in the scenario list.

In an advantageous embodiment of the present invention, the event list further comprises basic event probabilities associated with the basic events.

In an advantageous embodiment of the present invention, the basic events and the basic event probabilities are extracted from the tree structure to populate the event list.

In an advantageous embodiment of the present invention, the specific risk matrix further comprises a plurality of contributor columns for the contributing events up to a maximum number of the contributing events defined for any one of the scenarios.

In an advantageous embodiment of the present invention, the specific risk matrix further comprises a plurality of rows for pairings of an occurrence of each of the basic events in combination with each of the scenarios.

In an advantageous embodiment of the present invention, each of a plurality of probability values for the contributor columns is populated with each of the basic event probabilities that map to each of the contributing events.

In an advantageous embodiment of the present invention, each of the probability values for unpopulated locations in the contributor columns is populated with a value of one, and each of the probability values for locations in the contributor columns that map to the occurrence of each of the basic events in each of the rows is populated with a value of one.

In an advantageous embodiment of the present invention, each of the combined probabilities is calculated as a product of each of the probability values across the contributor columns of each of the rows.

In an advantageous embodiment of the present invention, the residual probability for each of the events is output to a report that associates each of the events with an event description and the residual probability for each of the events in a sorted order from a highest residual probability to a lowest residual probability.

In an advantageous embodiment of the present invention, formatting of the report distinguishes values of the residual probability relative to one or more threshold values.

In an advantageous embodiment of the present invention, the tree structure is a fault tree developed by a fault tree analysis tool, the scenario list is a list of cutset scenarios, and the event list and the scenario list are output by the fault tree analysis tool.

In an advantageous embodiment of the present invention, the event list and the scenario list are accessed by one or more applications external to the fault tree analysis tool to build the specific risk matrix and output the residual probability for each of the events.

In an advantageous embodiment of the present invention, the event list and the scenario list are reformatted by a spreadsheet application and imported into a database application to build the specific risk matrix and output the residual probability for each of the events.

In an advantageous embodiment of the present invention, the tree structure comprises an event node for each of the events and an event probability that is based on a failure rate, an exposure time, and a probability type.

In an advantageous embodiment of the present invention, the probability type for each event node having to an average probability is changed to a worst-case probability, and the event probability is updated prior to calculation of the combined probabilities.

In an advantageous embodiment of the present invention, the tree structure is a fault tree structure for a system of an aircraft, and the exposure time is set to a maximum mission flight time for the aircraft.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIG. 1 is a block diagram of a system in accordance with an embodiment of the present invention;

FIG. 2 is a block diagram of various applications and files in accordance with an embodiment of the present invention;

FIG. 3 is a block diagram of another system in accordance with an embodiment of the present invention;

FIG. 4 is a block diagram of a tree structure in accordance with an embodiment of the present invention;

FIG. 5 is an example of a scenario list in accordance with an embodiment of the present invention;

FIG. 6 is an example of an event list in accordance with an embodiment of the present invention;

FIG. 7 is an example of a specific risk matrix in accordance with an embodiment of the present invention;

FIG. 8 is an example of the specific risk matrix of FIG. 7 after a transformation process in accordance with an embodiment of the present invention;

FIG. 9 is an example of the specific risk matrix of FIG. 8 after an evaluation process in accordance with an embodiment of the present invention;

FIG. 10 is an example of a report output in accordance with an embodiment of the present invention;

FIG. 11 is a flowchart of exemplary steps executed by a processor in a method for carrying out specific risk analysis in accordance with embodiments of the present invention; and

FIG. 12 is a flowchart of additional exemplary steps executed by a processor in a method for carrying out specific risk analysis in accordance with embodiments of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially.” may not to be limited to the precise value specified, in some cases. In at least some instances, the approximating language may correspond to the precision of calculating and/or storing the value.

In embodiments of the present invention, a specific risk toolkit is provided that accesses an event list which defines a plurality of events and a scenario list that defines a plurality of scenarios as routes through a tree structure that includes one or more of the events for each of the scenarios. The tree structure may be a fault tree developed and modified by a fault tree analysis tool. The fault tree analysis tool can generate the event list and the scenario list based on events and associated probabilities defined in the fault tree. To support an analysis process that includes setting a sequence of events in the fault tree, rather than requiring a user to manually set each event in the fault tree using a graphical user interface (GUI) of the fault tree analysis tool, embodiments provide an automated process of calculating combined probabilities and accumulating the combined probabilities to generate and output a residual probability for each of the events. For example, calculating a top-level probability to capture the results of setting an occurrence of each basic event (i.e., fault) in a fault tree can be performed by manually changing event states in a series of iterations using the GUI of the fault tree analysis tool. In an embodiment, rather than performing a manual analysis, the specific risk toolkit uses a scenario list, such as a cutset scenario list generated by the fault tree analysis tool, and an event list to build a specific risk matrix that calculates a plurality of combined probabilities based on each pairing of an occurrence of each of the events in combination with each of the scenarios. The specific risk toolkit can output a residual probability for each of the events based on a summation of the combined probabilities for each of the events. A matrix based approach can calculate substantially similar results as achieved in individual iterations of the setting and changing event states using the GUI of the fault tree analysis tool; however, the matrix based approach can calculate all of the results at substantially the same time without prolonged delays associated with a series of manual interactions.

The foregoing and other features of various disclosed embodiments of the invention will be more readily apparent from the following detailed description and drawings of the illustrative embodiments of the invention wherein like reference numbers refer to similar elements.

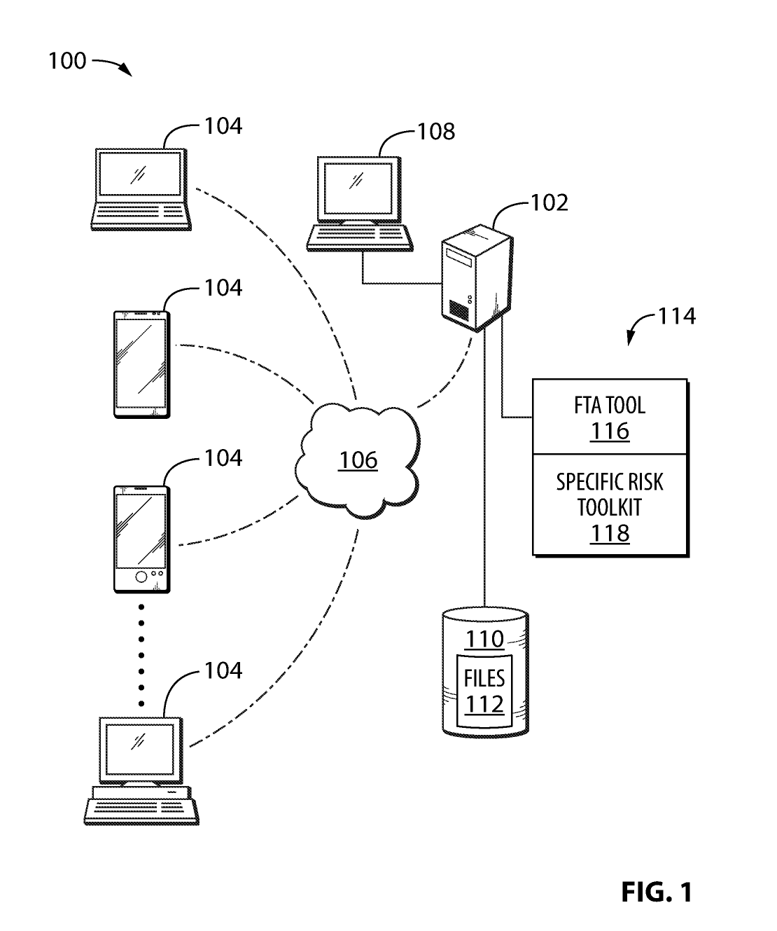

Referring to FIG. 1, there illustrated is a block diagram of a portion of a system 100 that implements specific risk analysis according to embodiments of the present invention.

The system 100 represents a networked environment; however, it will be understood that non-networked embodiments are also contemplated. In the example depicted in FIG. 1, the system 100 includes a host system 102 that may be configured to communicate with one or more client systems 104 over a communication network 106. In exemplary embodiments, the host system 102 is a high-speed processing device (e.g., a mainframe computer, a desktop computer, a laptop computer, a hand-held device, an embedded computing device, or the like) including at least one processor (e.g., a computer processor or processing circuit) capable of reading and executing instructions, and handling interactions with various components of the system 100.

In exemplary embodiments, the client systems 104, each generally referred to as a client system 104, can include a variety of computing devices with processors and I/O interfaces, such as a keys/buttons, a touchscreen, and a display device. Embodiments of the client systems 104 can include a personal computer (e.g., a laptop, desktop, etc.), a portable device (e.g., a tablet PC, personal digital assistant, smart phone, etc.), or a network server-attached terminal. Alternatively, the client systems 104 can be omitted. The host system 102 and client systems 104 can include various computer/communication hardware and software technology known in the art, such as one or more processors or circuits, volatile and non-volatile memory including removable media, power supplies, network interfaces, support circuitry, operating systems, and the like. The host system 102 may also include one or more user interfaces 108 with user accessible I/O devices, such as a keyboard, mouse, and display to provide local access to the host system 102.

The communication network 106 may be any type of communications network known in the art. The communication network 106 can include a combination of wireless, wired, and/or fiber optic links. The communication network 106 may support a variety of known communication standards that allow data to be transmitted between the host system 102 and the client systems 104. Additional computer systems (not depicted) may also interface with the host system 102 and/or the client systems 104 via the communication network 106 or other networks.

In exemplary embodiments, the host system 102 is communicatively coupled to a storage device 110. The storage device 110 stores files 112. The storage device 110 may be implemented using memory contained in the host system 102, or the storage device 110 may be a separate physical device. It will be understood that multiple storage devices may be employed. For example, the storage devices may be dispersed across the communication network 106, and each of the storage devices may be logically addressable as a consolidated data source across a distributed environment that includes the communication network 106.

Information stored in the storage device 110 may be retrieved and manipulated via the host system 102. The data storage device 110 may generally store program instructions, code, and/or modules that, when executed by a processor, cause a particular machine to function in accordance with one or more embodiments described herein. The data storage device 110 depicted in FIG. 1 is representative of a class and/or subset of computer-readable media that are defined herein as “computer-readable memory” (e.g., non-transitory memory as opposed to transmission devices or media).

The host system 102 can execute one or more applications 114, including a fault tree analysis (FTA) tool 116 and a specific risk toolkit 118. In an alternate embodiment, the host system 102 provides the applications 114 or portions thereof to be executed by one or more of the client systems 104. The FTA tool 116 can generate or modify one or more tree structures, such as a fault tree structure. The FTA tool 116 can save data related to tree structures in the files 112. The specific risk toolkit 118 operates on data related to tree structures, for example, by reading the files 112, and outputs one or more reports that may also be stored in the files 112. Instructions for executing the FTA tool 116 and the specific risk toolkit 118 can be stored in the files 112 and may be transferred to other locations in memory within the host system 102 or the client systems 104 for execution. Although depicted separately, it will be understood that the FTA tool 116 and the specific risk toolkit 118 can form a single application. Further details regarding the FTA tool 116 and the specific risk toolkit 118 are provided herein.

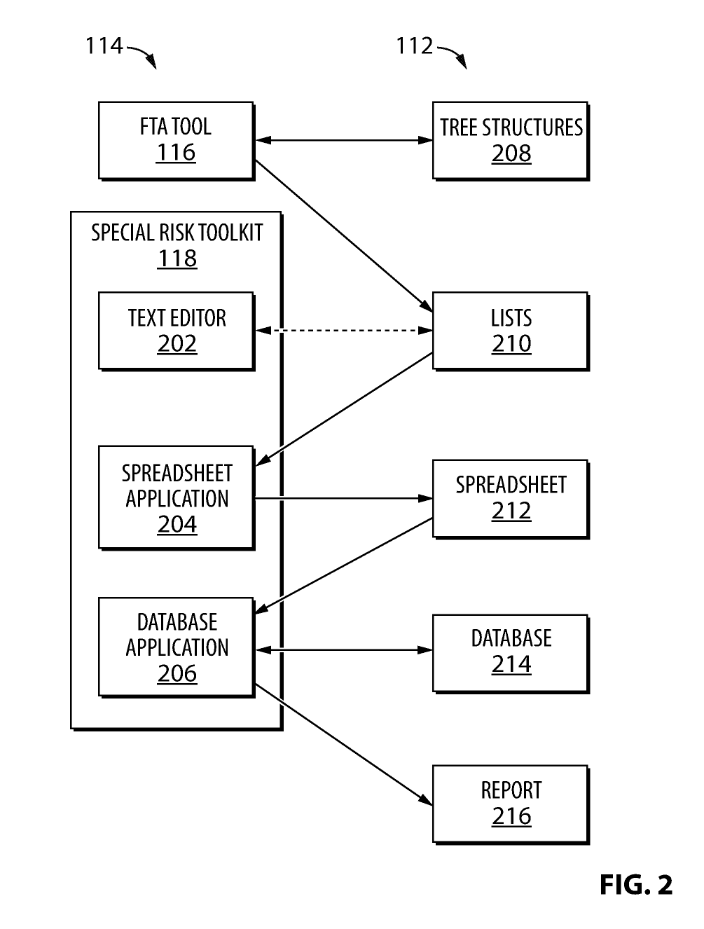

FIG. 2 is a block diagram of various applications 114 and files 112 in accordance with an embodiment of the present invention. In the example of FIG. 2, the FTA tool 116 is a separate application with respect to the specific risk toolkit 118. As depicted in FIG. 2, the specific risk toolkit 118 can incorporate a number of other applications, such as a text editor 202, a spreadsheet application 204, and a database application 206. Additional applications (not depicted) can also be included within the specific risk toolkit 118. In an alternate embodiment, the specific risk toolkit 118 may exclude the text editor 202. As further alternatives, the specific risk toolkit 118 may include either the spreadsheet application 204 or the database application 206, but not both.

In further reference to FIG. 2, the FTA tool 116 can access one or more tree structures 208, which may be stored in the files 112. Each of the tree structures 208 may be a fault tree associated with, for example, a control system or subsystem of an aircraft. The FTA tool 116 can output one or more lists 210 based on the tree structures 208. The lists 210 can include event lists that define events and probabilities of each of the events from the tree structures 208. The lists 210 may also include scenario lists that define routes through the tree structures 208, where each scenario includes one or more events. In creating the lists 210, the FTA tool 116 may omit values from the tree structures 208 that are not relevant to performing specific risk calculations, such as undeveloped events. Alternatively, any extraneous information included in the lists 210 can be filtered out or ignored during further processing and formatting steps described herein.

The text editor 202 may be used to reformat the lists 210 and/or save the lists 210 into a different file format that is supported by the spreadsheet application 204. Alternatively, the lists 210 may be directly accessible by the spreadsheet application 204 without modification by the text editor 202. The spreadsheet application 204 can generate a spreadsheet 212 associated with each of the lists 210. Alternatively, a single instance of the spreadsheet 212 can incorporate values from multiple lists 210. As one example, the lists 210 can be converted by the spreadsheet application 204 from a comma delimited format to a table format in the spreadsheet 212.

The database application 206 can read the spreadsheet 212 and create or update a database 214 with a specific risk matrix that includes residual probabilities for each of the events from the lists 210. The database application 206 can also output a report 216 that summarizes events, event descriptions, and the residual probabilities of the events. The tree structures 208, lists 210, spreadsheet 212, database 214, and report 216 may all be stored in files 112, for instance, on the storage device 110 of FIG. 1. Further details regarding the creation of a specific risk matrix is provided herein.

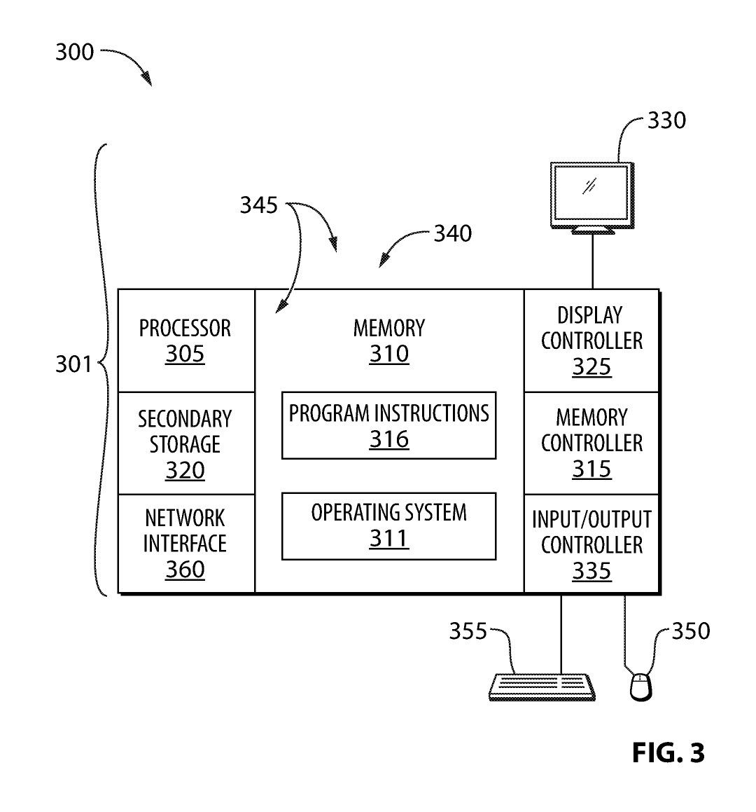

FIG. 3 depicts a block diagram of a system 300 according to an embodiment. The system 300 is depicted embodied in a computer 301 in FIG. 3, such as a general-purpose computer, configured to perform specific risk assessment. The system 300 is an example of the host system 102 of FIG. 1. The client systems 104 of FIG. 1 can also include similar computer elements as depicted in the computer 301 of FIG. 3.

In an exemplary embodiment, in terms of hardware architecture, as shown in FIG. 3, the computer 301 includes a processor 305 and a memory device 310 coupled to a memory controller 315 and an input/output controller 335. The input/output controller 335 can be, for example but not limited to, one or more buses or other wired or wireless connections, as is known in the art. The input/output controller 335 may have additional elements, which are omitted for simplicity, such as controllers, buffers (caches), drivers, repeaters, and receivers, to enable communications. Further, the computer 301 may include address, control, and/or data connections to enable appropriate communications among the aforementioned components.

In an exemplary embodiment, a conventional keyboard 350 and mouse 355 or similar devices can be coupled to the input/output controller 335. Alternatively, input may be received via a touch-sensitive or motion sensitive interface (not depicted). The computer 301 can further include a display controller 325 coupled to a display 330.

The processor 305 is a hardware device for executing software, particularly software stored in secondary storage 320 or memory device 310, where the memory device 310 and secondary storage 320 may be collectively referred to as a memory system 345 in communication with the processor 305. The processor 305 can be any custom made or commercially available computer processor, a central processing unit (CPU), an auxiliary processor among several processors associated with the computer 201, a semiconductor-based microprocessor (in the form of a microchip or chip set), a macro-processor, processing circuitry, or generally any device for executing instructions.

The memory device 310 of the memory system 345 can include any one or combination of volatile memory elements (e.g., random access memory (RAM, such as DRAM, SRAM. SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory device 310 may incorporate electronic, magnetic, optical, and/or other types of storage media. Accordingly, the memory device 310 is an example of a tangible computer readable storage medium 340 upon which instructions executable by the processor 305 may be embodied as a computer program product. The memory device 310 can have a distributed architecture, where various components are situated remote from one another, but can be accessed by the processor 305. Similarly, the secondary storage 320 of the memory system 345 can include nonvolatile memory elements and may be an embodiment of the storage device 110 of FIG. 1 to store files 112 of FIG. 1.

The instructions in the memory device 310 may include one or more separate programs, each of which comprises an ordered listing of executable instructions for implementing logical functions. In the example of FIG. 3, the instructions in the memory device 310 include a suitable operating system (OS) 311 and program instructions 316. The operating system 311 essentially controls the execution of other computer programs and provides scheduling, input-output control, file and data management, memory management, and communication control and related services. When the computer 301 is in operation, the processor 305 is configured to execute instructions stored within the memory device 310, to communicate data to and from the memory device 310, and to generally control operations of the computer 301 pursuant to the instructions. Examples of program instructions 316 can include instructions to implement the applications 114 of FIG. 1, such as the FTA tool 116 and the specific risk toolkit 118 of FIG. 1, where the system 300 is an embodiment of the host system 102 of FIG. 1. Further examples of the program instructions 316 can include instructions to implement the text editor 202, the spreadsheet application 204, and/or the database application 206 of FIG. 2.

The computer 301 of FIG. 3 may also include a network interface 360 that can establish communication channels with one or more other computer systems via one or more network links, for instance in the communication network 106 of FIG. 1. The network interface 360 can support wired and/or wireless communication protocols known in the art. For example, when embodied in the host system 102 of FIG. 1, the network interface 360 can establish communication channels with one or more of the client systems 104 of FIG. 1.

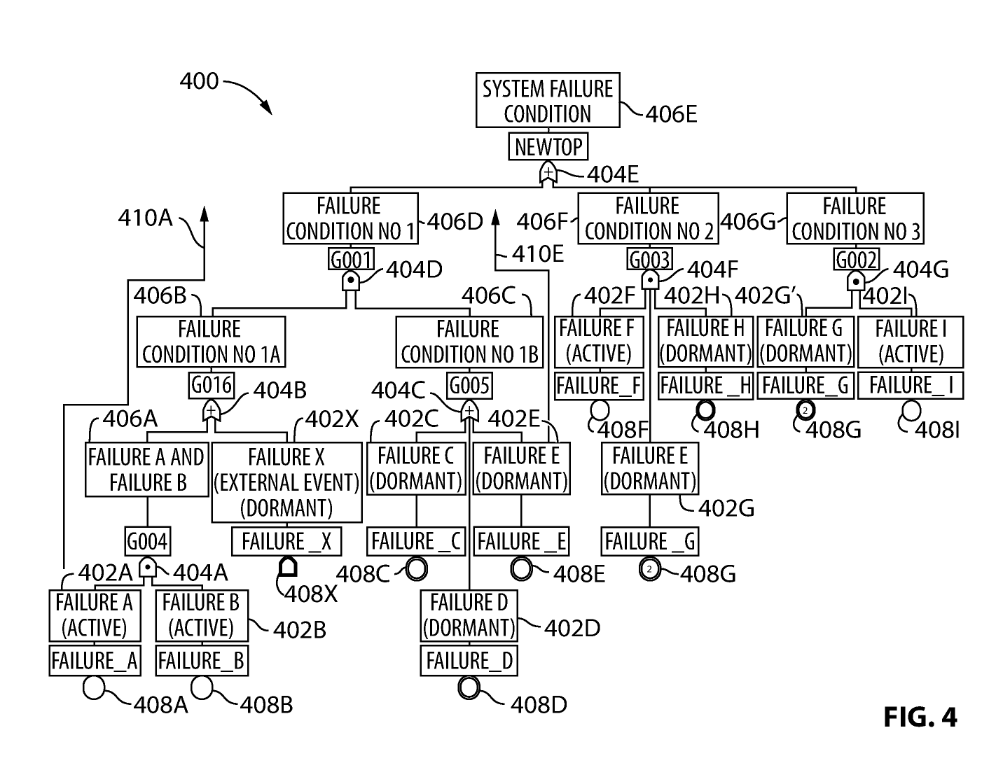

Turning now to FIG. 4, a block diagram of a tree structure 400 is depicted in accordance with an embodiment of the present invention. The tree structure 400 is an example of one of the tree structures 208 of FIG. 2. The tree structure 400 includes a plurality of nodes that can include event nodes 402, logic gates 404, and condition nodes 406. Event nodes 402 may define a number of parameters such as an event probability (p), a failure rate (λ), an exposure time (τ), and a probability type (c). The failure rate (λ) can define an expected frequency of occurrence of the associated event. The exposure time (τ) is a period of time over which there is exposure to the event. For instance, in the context of an aircraft, the exposure time (τ) can be a maximum mission flight time. A worst-case probability can be calculated, for example, when probability type (c) is one according to equation 1 as follows:

p=π·τ (Eq. 1)

An average probability for a dormant failure can be calculated, for example, when probability type (c) is two, according to equation 2 as follows:

$$p = \frac{λ \cdot τ}{2} \qquad ( Eq . 2 )$$

An alternate form of the worst-case probability can be calculated, for example, when probability type (c) is three according to equation 3 as follows:

p=1−e^{-λτ} (Eq. 3)

Each event node 402 may also be referred to as a bottom event of the tree structure 400. Each event node 402 can define a failure event or other type of event, such as an external event or an undefined event. In the example of FIG. 4, the logic gates 404 can be AND gates or OR gates that implement known AND/OR logical functions. The condition nodes 406 each indicate a condition state and an associated probability based on the probabilities flowed up from lower-level nodes and based on the gate types providing input to the condition nodes 406.

In the example of FIG. 4, an event node 402A and an event node 402B are connected to an AND gate 404A as inputs. The AND gate 404A provides output to a condition node 406A. An OR gate 404B receives input from the condition node 406A and an external event node 402X. A condition node 406B receives output from the OR gate 404B. An OR gate 404C is connected to event nodes 402C, 402D, and 402E. Output of the OR gate 404C is provided to a condition node 406C. The condition nodes 406B and 406C provide input to an AND gate 404D. A condition node 406D receives output from the AND gate 404D. An OR gate 404E receives input from condition nodes 406D, 406F, and 406G and provides output to a condition node 406E, where the condition node 406E is a top-level node or root of the tree structure 400.

Event nodes 402F. 402G, and 402H are connected to an AND gate 404F. The AND gate 404F provides output to a condition node 406F, which in turn is provided to the OR gate 404E. Event nodes 402G′ and 402I are connected to an AND gate 404G. Output of the AND gate 404G is provided to a condition node 406G, which in turn is provided to the OR gate 404E. Accordingly, the probability of a system failure condition at the condition node 406E depends upon probabilities of the condition nodes 406D, 406F, and 406G. The probability of a failure condition at the condition node 406D depends upon probabilities of the condition nodes 406B and 406C. The probability of a failure condition at the condition node 406B may depend upon a probability of the condition node 406A and the external event node 402X.

To observe the effects of setting a single event failure in combination with the remaining failure probabilities, events 408 can be set individually and the probability at the condition node 406E observed for events 408A, 408B, 408C, 408D. 408E, 408F, 408G, 408H. 408I, and 408X, where like numbered events 408 set like numbered event nodes 406. For example, event 408A (Failure A) sets the event node 402A, event 408B (Failure B) sets the event node 402B, event 408C (Failure C) sets the event node 402C, event 408D (Failure D) sets the event node 402D, event 408E (Failure E) sets the event node 402E, event 408F (Failure F) sets the event node 402F, event 408G (Failure G) sets the event nodes 402G and 402G′, event 408H (Failure H) sets the event node 402H, event 408I (Failure I) sets the event node 402I, and event 408X (Failure X) sets the external event node 402X.

Various paths or routes 410 can be defined between the events 408 and the condition node 406E. For example, route 410A can propagate the event 408A from event node 402 through AND gate 404A, condition node 406A, OR gate 404B, condition node 406B, AND gate 404D, condition node 406D, and OR gate 404E to the condition node 406E. Similarly, route 410E can propagate the event 408E from event node 402E through OR gate 404C, condition node 406C, AND gate 404D, condition node 406D, and OR gate 404E to condition node 406E. A cutset scenario is defined by each combination of contributing events that can set the condition node 406E at the top-level of the tree structure 400. For instance, one cutset scenario is a combination of events 408A, 408B, and 408E, as routes 410A and 410E merge at the AND gate 404D and pass through the OR gate 404E to reach the condition node 406E.

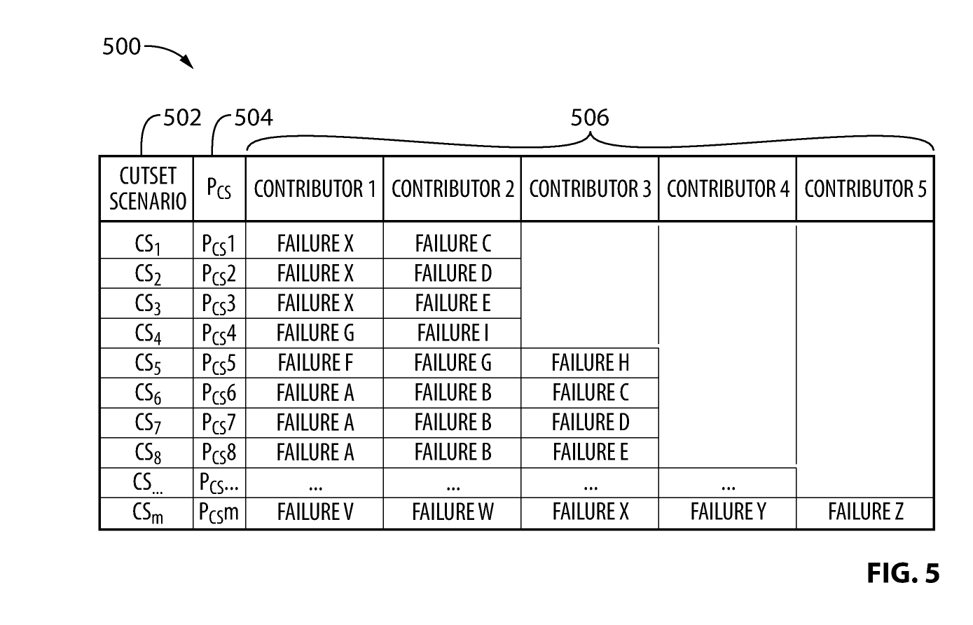

FIG. 5 is an example of a scenario list 500 in accordance with an embodiment of the present invention. The scenario list 500 can be one of the lists 210 of FIG. 2. The scenario list 500 defines a plurality of scenarios 502 as routes through a tree structure that includes one or more events for each of the scenarios 502. The scenarios 502 may be cutset scenarios, such as cutset scenarios CS₁, CS₂, CS₃, CS₄, CS₅, CS₆, CS₇, CS₈, . . . . CSₘ. The scenario list 500 can also include a scenario probability 504 for each of the scenarios 502, such as scenario probability P_{cs}1, P_{cs}2, P_{cs}3, P_{cs}4, P_{cs}5, P_{cs}6, P_{cs}7, P_{cs}8, . . . , P_{cs}m. Alternatively, the scenario probability 504 can be omitted. A plurality of contributing events 506 can be defined in the scenario list 500 as the one or more events for each of the scenarios 502. In the example of FIG. 5, a maximum number of the contributing events 506 defined for any one of the scenarios 502 is five (e.g., including contributor1, contributor2, contributor3, contributor4, and contributor5).

For purposes of explanation, the example of FIG. 5 substantially maps to the tree structure 400 of FIG. 4. For instance, the cutset scenario CS₈ includes route 410A for the events 408A (Failure A) and 408B (Failure B) as contributor1 and contributor2, and route 410E for the event 408E (Failure E) of FIG. 4 as contributor3. Other scenarios 502 include: cutset scenario CS₁ with Failure X and Failure C as contributor1 and contributor2; cutset scenario CS₂ with Failure X and Failure D as contributor1 and contributor2; cutset scenario CS₄ with Failure G and Failure I as contributor1 and contributor2; cutset scenario CS₅ with Failure F, Failure G, and Failure H as contributor1, contributor2, and contributor3; cutset scenario CS₆ with Failure A, Failure B, and Failure C as contributor1, contributor2, and contributor3; cutset scenario CS₇ with Failure A, Failure B, and Failure D as contributor1, contributor2, and contributor3; cutset scenario CS₃ with Failure X and Failure E as contributor1 and contributor2; and a general case as cutset scenario CSₘ with Failure V, Failure W. Failure X, Failure Y, and Failure Z as contributor1, contributor2, contributor3, contributor4, and contributor5.

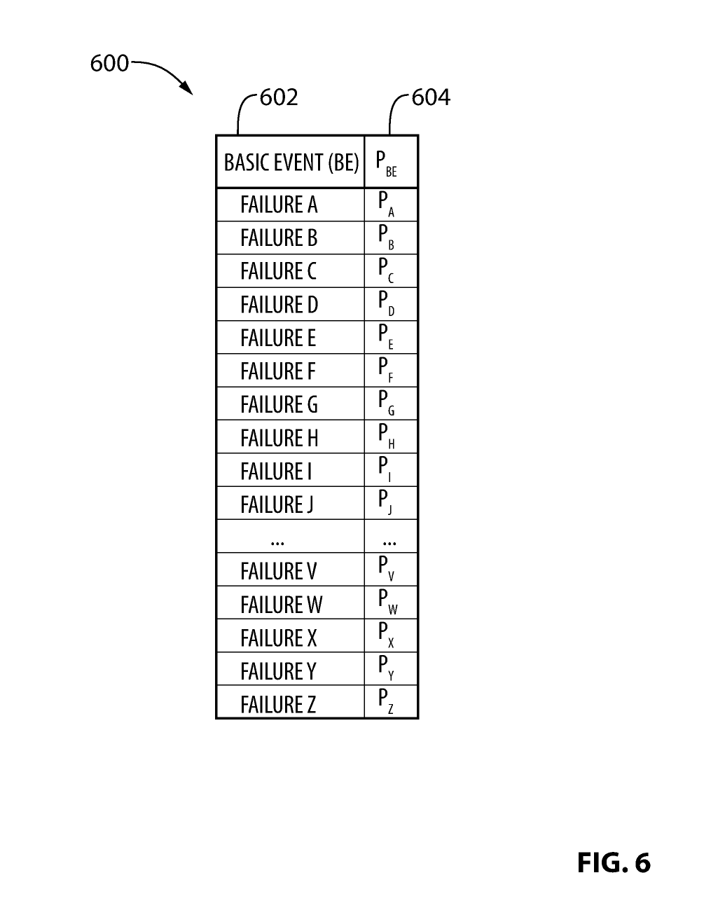

FIG. 6 is an example of an event list 600 in accordance with an embodiment of the present invention. The event list 600 can be one of the lists 210 of FIG. 2. The event list 600 defines a plurality of events which in the example of FIG. 6 include basic events 602. The basic events 602 can be mapped to the contributing events 506 of FIG. 5. The basic events 602 can include all of the basic events that are defined for a tree structure, such as events 408 of FIG. 4 and excluding or not event 408X of FIG. 4 which is an external event, not a basic event. In the example of FIG. 6, the basic events 602 of the event list 600 include: Failure A. Failure B. Failure C, Failure D, Failure E, Failure F. Failure G, Failure H. Failure I, Failure J, . . . , Failure V, Failure W, Failure X. Failure Y, and Failure Z. The event list 600 also includes basic event probabilities 604 associated with the basic events 602. In the example of FIG. 6, the event probabilities 604 in the event list 600 include: basic event probability P_{A} for Failure A, basic event probability P_{B} for Failure B, basic event probability P_{C} for Failure C, basic event probability P_{D} for Failure D, basic event probability P_{E} for Failure E, basic event probability P_{F} for Failure F, basic event probability P_{G} for Failure G, basic event probability P_{H} for Failure H, basic event probability P_{I} for Failure I, basic event probability P_{J} for Failure J, . . . , basic event probability P_{V} for Failure V, basic event probability P_{W} for Failure W, basic event probability P_{X} for Failure X, basic event probability P_{Y} for Failure Y, and basic event probability P_{Z} for Failure Z. The basic events 602 and the basic event probabilities 604 can be extracted from a tree structure to populate the event list 600, such as the FTA tool 116 of FIG. 2 extracting data from the tree structure 400 of FIG. 4 of tree structures 208 (FIG. 2).

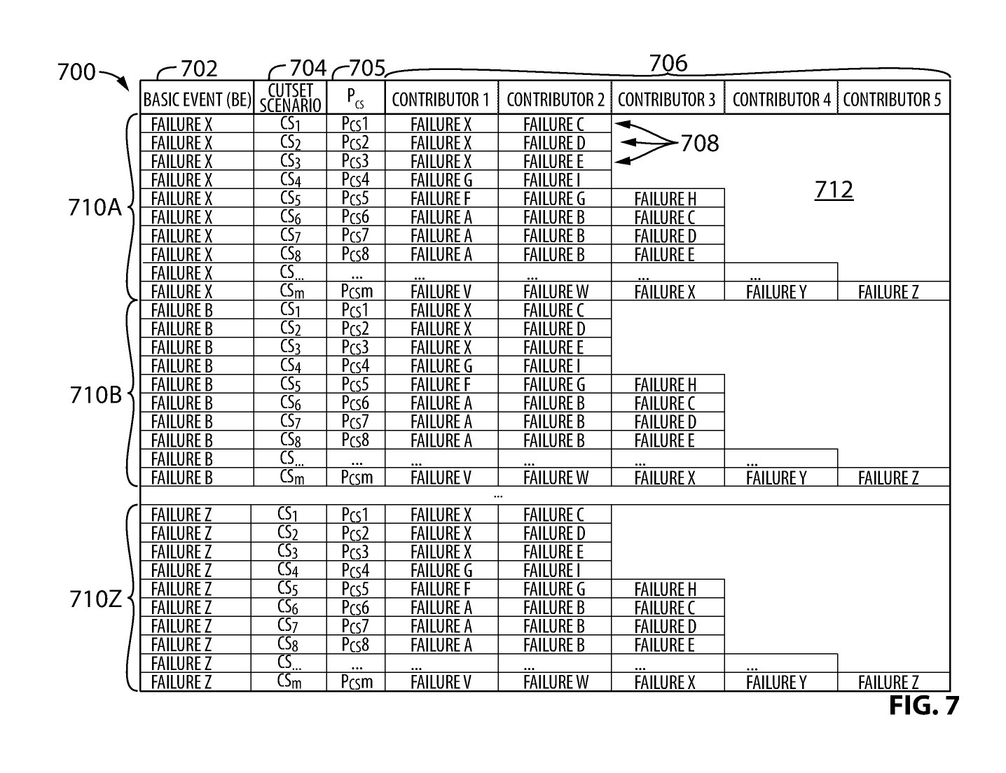

FIG. 7 is an example of a specific risk matrix 700 in accordance with an embodiment of the present invention. The specific risk matrix 700 can be embodied in the spreadsheet 212 or the database 214 of FIG. 2. The specific risk matrix 700 can include basic events 702, scenarios 704, and a plurality of contributor columns 706 for contributing events (e.g., contributor1, contributor2, contributor3, contributor4, and contributor5) up to a maximum number of the contributing events defined for any one of the scenarios 704. The specific risk matrix 700 can also include a scenario probability 705 for each of the scenarios 704. The specific risk matrix 700 includes a plurality of rows 708 for pairings of an occurrence of each of the basic events 602 of FIG. 6 in combination with each of the scenarios 502 of FIG. 5. Accordingly, the contributor columns 706 map to the contributing events 506 of FIG. 5.

In an embodiment where the specific risk matrix 700 is in the spreadsheet 212 or the database 214 of FIG. 2, the spreadsheet application 204 or the database application 206 of FIG. 2 can populate the specific risk matrix 700 in the spreadsheet 212 or in the database 214 by creating rows 708 for pairings of an occurrence of each of the basic events 602 of FIG. 6 in combination with each of the scenarios 502 of FIG. 5. This can result in copying the contents of scenario list 500 of FIG. 5 for a number of times equivalent to the number of basic events 602 defined in the event list 600 of FIG. 6 into the specific risk matrix 700. For example, a grouping 710K may be populated with a fixed value of Failure K for the basic events 702, and the scenarios 704, scenario probability 705, and contributor columns 706 may be populated with the scenarios 502, scenario probability 504, and contributing events 506 of FIG. 5. Groupings 710B through 710Z can similarly be populated with repeated values of Failure B and Failure Z respectively along with separate copies of the scenario list 500 of FIG. 5. Again, the scenario probability 705 need not be populated. A number of unpopulated locations 712 may be reserved in the contributor columns 706 where no contributor values are defined.

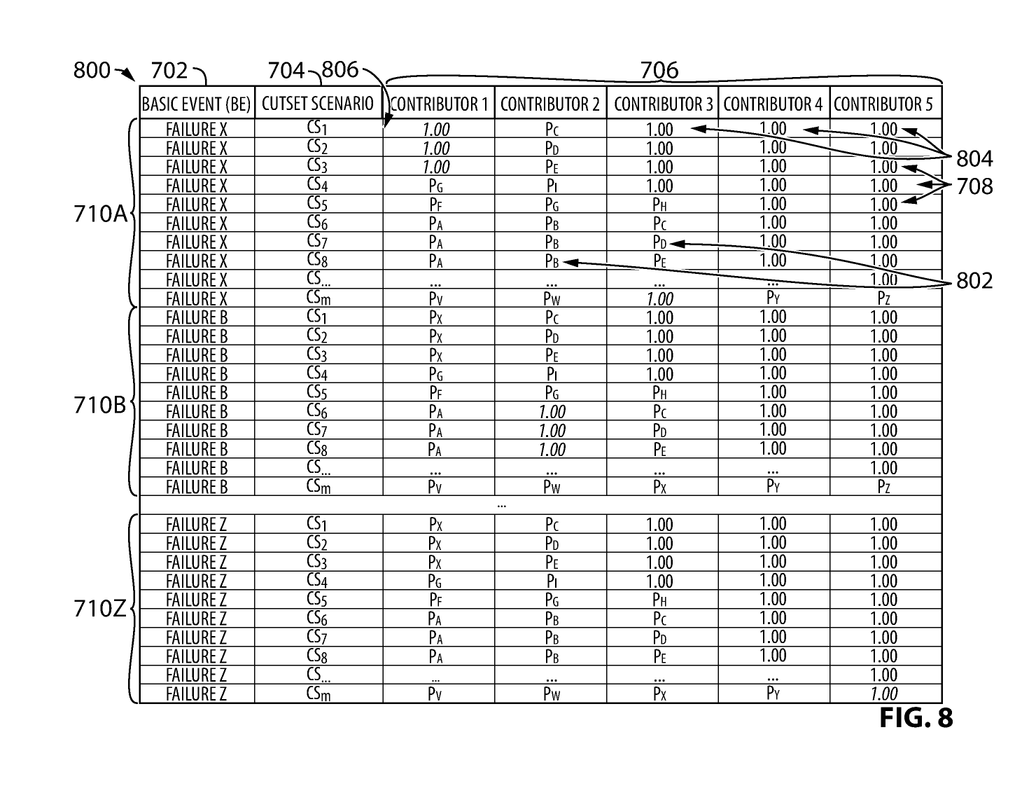

FIG. 8 is an example of the specific risk matrix 700 of FIG. 7 after a transformation process, and is thus referred to as specific risk matrix 800 in accordance with an embodiment of the present invention. The specific risk matrix 800 can be generated by the database application 206 of the specific risk toolkit 118 of FIG. 2 from the spreadsheet 212 of FIG. 2 and stored in the database 214 of FIG. 2. The specific risk matrix 800 includes the basic events 702, the scenarios 704, and contributor columns 706 of the specific risk matrix 700 of FIG. 7. The specific risk matrix 800 replaces contributing events in the contributor columns 706 with probability values 802. Each of a plurality of probability values 802 for the contributor columns 706 is populated with each of the basic event probabilities 604 of FIG. 6 that map to each of the contributing events. For example, in a pairing of an occurrence of Failure X and cutset scenario CS₁, the value for contributor2 is changed from Failure C to P_{C}. Each of the probability values 802 for unpopulated locations 712 of FIG. 7 in the contributor columns 706 is populated with a value of one. For example, in a pairing of an occurrence of Failure X and cutset scenario CS₁, the value for contributor3, contributor4, and contributor5 at locations 804 is changed one. Additionally, each of the probability values 802 for locations 806 in the contributor columns 706 that map to the occurrence of each of the basic events 702 in each of the rows 708 is populated with a value of one. For example, in grouping 710X, where the basic event 702 has a value of Failure X, any value in the contributor columns 706 of group 710X that is also Failure X is replaced by a one. e.g., contributor1 of cutset scenarios CS₁, CS₂, and CS₃ in group 710X.

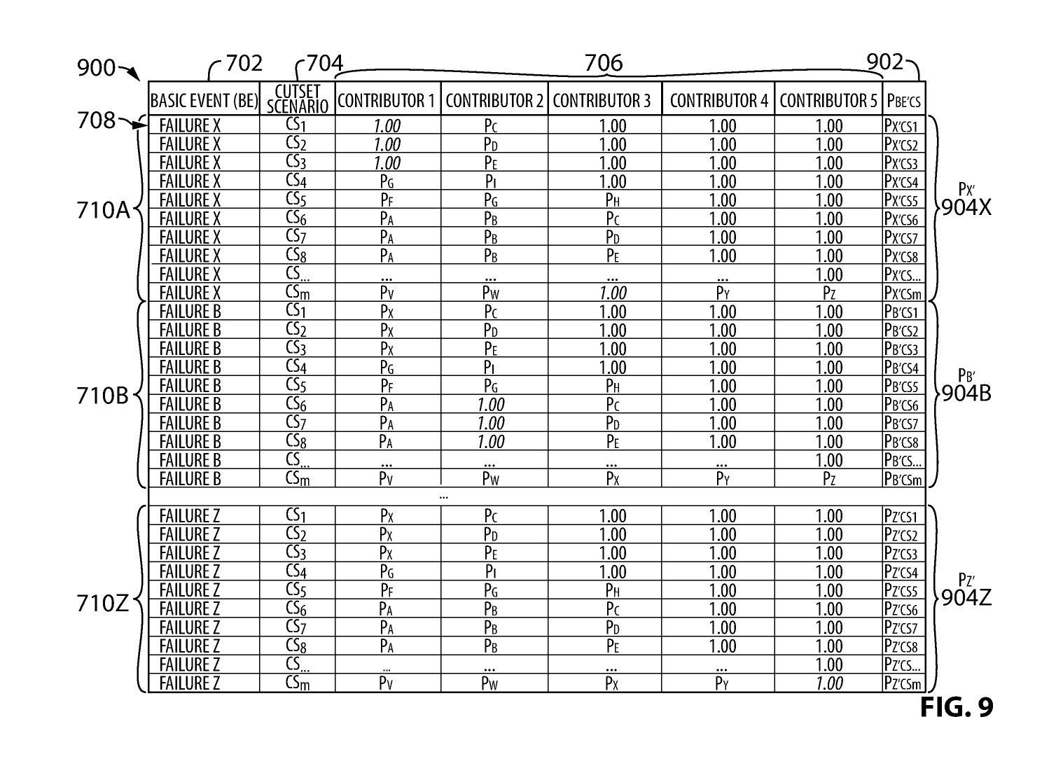

FIG. 9 is an example of the specific risk matrix 800 of FIG. 8 after an evaluation process, and is thus referred to as specific risk matrix 900 in accordance with an embodiment of the present invention. The specific risk matrix 900 can be generated by the database application 206 of the specific risk toolkit 118 of FIG. 2 and stored in the database 214 of FIG. 2. The specific risk matrix 900 calculates a plurality of combined probabilities 902 based on each pairing of an occurrence of each of the basic events 702 in combination with each of the scenarios 704. For each of the scenarios 704, the transformed values from the specific risk matrix 800 of FIG. 8 are retained in the contributor columns 706 of the specific risk matrix 900 and used for calculating the combined probabilities 902. The calculation can be a row multiplication operation. For instance, a combined probability P_{X′CS1} can be calculated where a value of Failure X is in the basic events 702 and CS₁ is in the scenarios 704, resulting a multiplication across the contributor columns 706 as 1.0 (contributor1)*P_{C} (contributor2)*1.0 (contributor3)*1.0 (contributor4)*1.0 (contributor5). The calculation process is continued across the contributor columns 706 and down each of the rows 708 to populate the combined probabilities 902.

A residual probability 904 can also be generated for each of the basic events 702 based on a summation of the combined probabilities 902 for each of the basic events 702. For example, a residual probability 904X (P_{X′}) can be calculated as the sum of the combined probabilities 902 (P_{X′CS1} to P_{X′CSm}) for grouping 710X. Similarly, for grouping 710B, residual probability 904B (P_{B′}) can be calculated as the sum of the combined probabilities 902 (P_{B′CS1} to P_{B′CSm}) for grouping 710B. The calculation process continues through grouping 710Z, where residual probability 904Z (P_{Z′}) can be calculated as the sum of the combined probabilities 902 (P_{Z′CS1} to P_{Z′CSm}) for grouping 710Z.

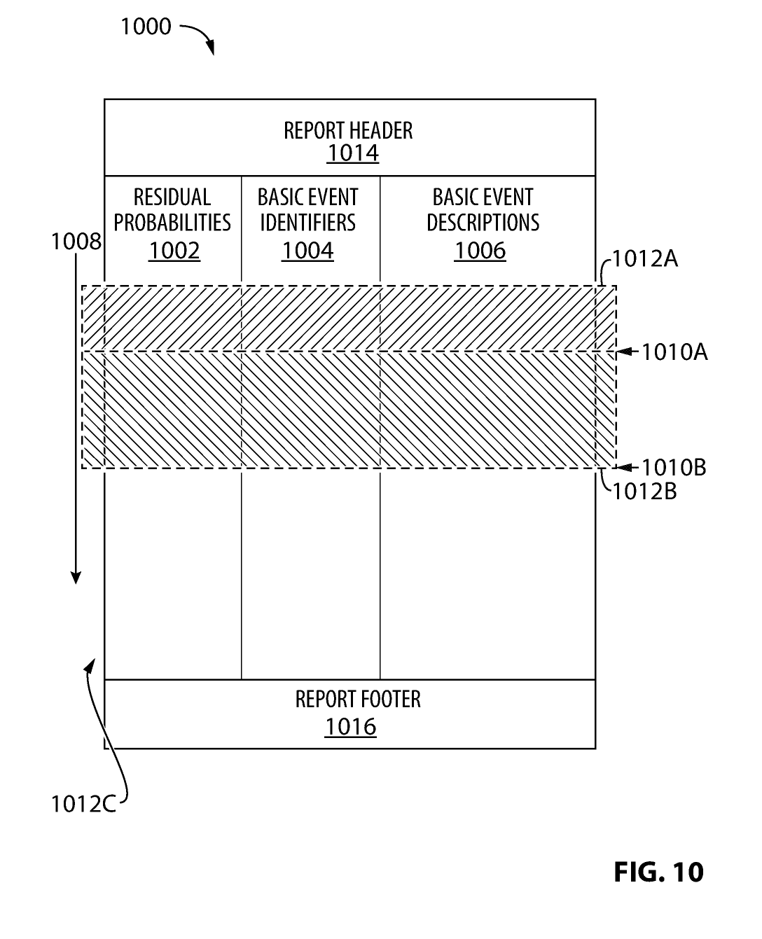

FIG. 10 is an example of a report 1000 that is output in accordance with an embodiment of the present invention. The report 1000 is an example of the report 216 of FIG. 2 that can be output by the specific risk toolkit 118 of FIG. 2 using, for example, the database application 206 of FIG. 2. The report 1000 can be generated upon calculation of the residual probabilities 904 of FIG. 9 for each of the basic events 702 of FIG. 9. In the report 1000, the residual probabilities 904 of FIG. 9 are associated with each of the basic events 702 of FIG. 9 along with an event description for each of the basic events 702 of FIG. 9. In the example of FIG. 10, the residual probabilities 904 of FIG. 9 are output as residual probabilities 1002, for instance in a column format. The basic events 702 of FIG. 9 associated with the residual probabilities 904 of FIG. 9 are output in basic event identifiers 1004, which may also be in a column format. Basic event descriptions 1006 hold event descriptions associated with each of the basic event identifiers 1004. The residual probabilities 1002 can be output in a sorted order 1008, for instance, from a highest residual probability to a lowest residual probability.

Different formatting may be used in the report 1000 to distinguish values of the residual probabilities 1002 relative to one or more threshold values 1010. For example, if a first threshold value 1010A defines a residual probability value above which is considered “unacceptable”, a first type of formatting 1012A can be applied to the residual probabilities 1002, basic event identifiers 1004, and/or basic event descriptions 1006 for values of the residual probabilities 1002 that exceed the first threshold value 1010A. If a second threshold value 1010B defines a residual probability value above which is considered “at risk”, a second type of formatting 1012B can be applied to the residual probabilities 1002, basic event identifiers 1004, and/or basic event descriptions 1006 for values of the residual probabilities 1002 that exceed the second threshold value 1010B but are less than the first threshold value 1010A. Remaining values of the residual probabilities 1002, basic event identifiers 1004, and/or basic event descriptions 1006 can have a default formatting 1012C. Examples of the first type of formatting 1012A and the second type of formatting 1012B can include differences in color, shading, font size, font type, boldface, underlining, or any other variation that produces a visual distinction relative to the default formatting 1012C.

A legend for the first type of formatting 1012A and the second type of formatting 1012B can be included in a report header 1014 or a report footer 1016, for example. The report header 1014 and report footer 1016 can also include other information, such as report generation information, page numbers, report date, document number, and the like. In one embodiment, the report header 1014 includes an identifier of a top-level system failure condition, such as a top-level system failure condition associated with the condition node 406E of the tree structure 400 of FIG. 4, where all of the residual probabilities 1002, basic event identifiers 1004, and basic event descriptions 1006 relate back to the top-level system failure condition.

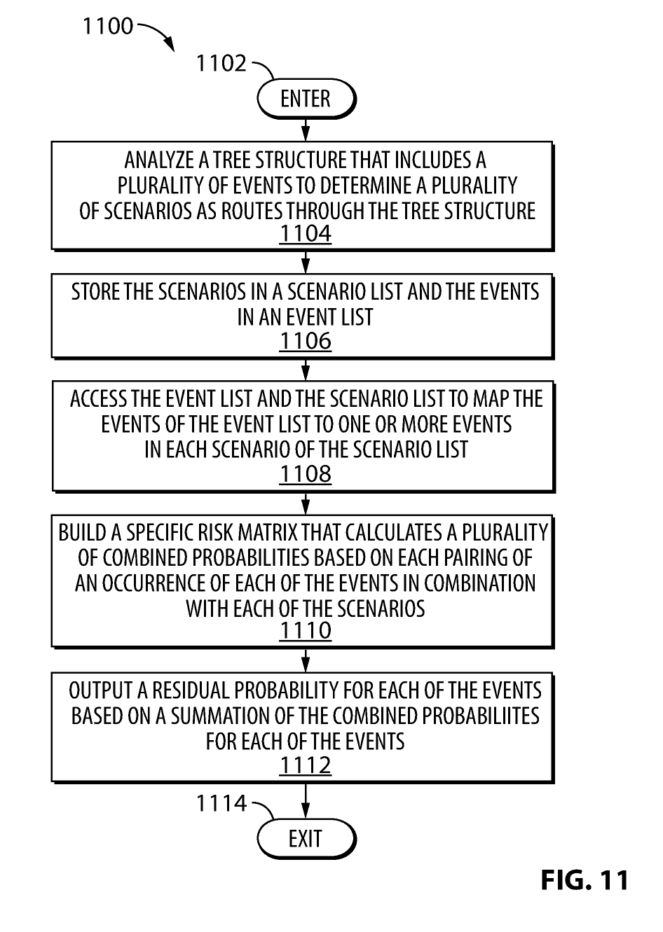

FIG. 11 is a flowchart of exemplary steps executed by a processor, such as the processor 305 of FIG. 3, in a method 1100 for carrying out specific risk analysis in accordance with embodiments of the present invention. The method 1100 can be performed by the host system 102 of FIG. 1. After an enter step 1102, a step 1104 is executed in which a tree structure is analyzed that includes a plurality of events to determine a plurality of scenarios as routes through the tree structure. For example, the FTA tool 116 of FIG. 1 can analyze the tree structure 400 of FIG. 4 to determine scenarios 502 of FIG. 5 as routes, such as routes 410A and 410E of FIG. 4, for events 408 of FIG. 4 to propagate through the tree structure 400 of FIG. 4. The tree structure 400 of FIG. 4 may be a fault tree developed by the FTA tool 116 of FIG. 1.

As previously described in reference to FIG. 4, the tree structure 400 can include an event node 402 for each of the events 408 and an event probability (p) that is based on a failure rate (λ), an exposure time (τ), and a probability type (c). The probability type (c) for each event node 402 that is defined as an average probability can be changed to a worst-case probability, with the event probability (p) updated prior to performing further calculations using the event probability (p). In an embodiment where the tree structure 400 of FIG. 4 is a fault tree structure for a system of an aircraft, the exposure time (τ) can be set to a maximum mission flight time for the aircraft to ensure that a worst case analysis is performed.

At step 1106, the scenarios are stored in a scenario list, and the events are stored in an event list. Step 1106 can be performed by the FTA tool 116 of FIG. 1. With respect to the example of FIGS. 5 and 6, the scenarios are the scenarios 502 of the scenario list 500, and the events of step 1106 can be the basic events 602 in the event list 600. As previously described in reference to FIG. 5, each of the scenarios 502 includes one or more events that are referred to as contributing events 506 in the scenario list 500. The event list 600 of FIG. 6 also includes basic event probabilities 604 associated with the basic events 602. The basic events 602 and the basic event probabilities 604 can be extracted from the tree structure 400 of FIG. 4 to populate the event list 600.

At step 1108, the event list 600 of FIG. 6 and the scenario list 500 of FIG. 5 are accessed to map the basic events 602 of the event list 600 to one or more contributing events 506 in each scenario 502 of the scenario list 500. The scenario list 500 of FIG. 5 may be a list of cutset scenarios from the tree structure 400 of FIG. 4. The event list 600 of FIG. 6 and the scenario list 500 of FIG. 5 can be output by the FTA tool 116 of FIG. 1, and may be accessed by one or more applications external to the FTA tool 116. For example, the event list 600 and the scenario list 500 can be reformatted by the spreadsheet application 204 of FIG. 2 and imported into the database application 206 of FIG. 2.

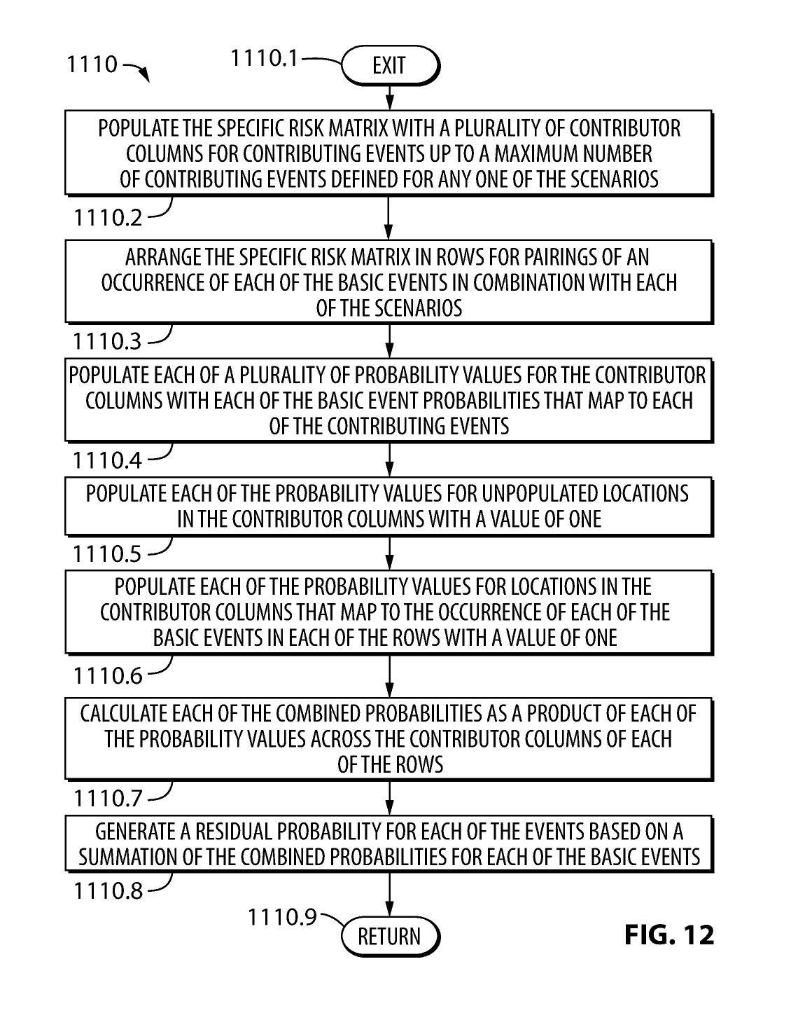

At step 1110, a specific risk matrix is built that calculates a plurality of combined probabilities based on each pairing of an occurrence of each of the events in combination with each of the scenarios. This process is further defined according to steps 1110.1-1110.9 of FIG. 12. After an entry step 1110.1, a step 1110.2 is executed in which the specific risk matrix 700 of FIG. 7 is populated with a plurality of contributor columns 706 for the contributing events (e.g., contributor1, contributor2, contributor3, contributor4, and contributor5) up to a maximum number of the contributing events defined for any one of the scenarios 704. As previously described, the contents of the scenarios 704 and contributor columns 706 of the specific risk matrix 700 of FIG. 7 can be copied in from the scenarios 502 and contributing events 506 of FIG. 5.

At step 1110.3, the specific risk matrix 700 of FIG. 7 is arranged in rows 708 for pairings of an occurrence of each of the basic events 702 in combination with each of the scenarios 704. Again, the contents of the basic events 702 can be copied in from the basic events 602 of FIG. 6.

At step 1110.4, a transformation is performed from the specific risk matrix 700 of FIG. 7 to the specific risk matrix 800 of FIG. 8, where each of a plurality of probability values 802 of FIG. 8 for the contributor columns 706 is populated with each of the basic event probabilities 604 of FIG. 6 that map to each of the contributing events in the contributor columns 706.

At step 1110.5, each of the probability values 802 for unpopulated locations 712 of FIG. 7 in the contributor columns 706 is populated in the specific risk matrix 800 of FIG. 8 with a value of one at locations 804 of FIG. 8. At step 1110.6, each of the probability values 802 for locations 806 of FIG. 8 in the contributor columns 706 that map to the occurrence of each of the basic events 702 in each of the rows 708 is populated with a value of one.

At step 1110.7, an evaluation is performed on the specific risk matrix 900 of FIG. 9, where each of the combined probabilities 902 of FIG. 9 is calculated as a product of each of the probability values 802 across the contributor columns 706 of each of the rows 708. At step 1110.8, a residual probability 904 is generated for each of the basic events 702 based on a summation of the combined probabilities 902 for each of the basic events 702. At step 1110.9, the step 1110 completes and the method 1100 returns to step 1112 of FIG. 11.

Returning to FIG. 11, at step 1112, the residual probability 904 is output for each of the basic events 702. The residual probability 904 for each of the events can be output to the report 1000 of FIG. 10 in residual probabilities 1002 of FIG. 10. The report 1000 of FIG. 10 associates each of the events with an event description, for instance as basic event identifiers 1004 and basic event descriptions 1006, and the residual probabilities 1002. The report 1000 of FIG. 10 can be organized in a sorted order 1008 from a highest residual probability to a lowest residual probability of the residual probabilities 1002. Formatting of the report 1000 can distinguish values of the residual probabilities 1002 relative to one or more threshold values 1010A and 1010B. The method 1100 exits at step 1114 of FIG. 11.

It will be appreciated that aspects of the present invention may be embodied as a system, method or computer program product and may take the form of a hardware embodiment, a software embodiment (including firmware, resident software, micro-code, etc.) or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Visual Basic, Smalltalk. C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. The program code may also be referred to as “computer program instructions” or more simply as “program instructions”, such as the program instructions 316 of FIG. 3.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors. CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A system, comprising:
a processor; and
a memory system in communication with the processor, the memory system storing instructions that when executed by the processor result in the system being operable to access an event list that defines a plurality of events and a scenario list that defines a plurality of scenarios as routes through a tree structure that comprises one or more of the events for each of the scenarios, the system also being operable to build a specific risk matrix that calculates a plurality of combined probabilities based on each pairing of an occurrence of each of the events in combination with each of the scenarios, and the system further being operable to output a residual probability for each of the events based on a summation of the combined probabilities for each of the events.

2. The system of claim 1, wherein the events in the event list comprise basic events, and the one or more of the events for each of the scenarios comprise a plurality of contributing events in the scenario list.

3. The system of claim 2, wherein the event list further comprises basic event probabilities associated with the basic events.

4. The system of claim 3, wherein the basic events and the basic event probabilities are extracted from the tree structure to populate the event list.

5. The system of claim 3, wherein the specific risk matrix further comprises a plurality of contributor columns for the contributing events up to a maximum number of the contributing events defined for any one of the scenarios.

6. The system of claim 5, wherein the specific risk matrix further comprises a plurality of rows for pairings of an occurrence of each of the basic events in combination with each of the scenarios.

7. The system of claim 6, wherein each of a plurality of probability values for the contributor columns is populated with each of the basic event probabilities that map to each of the contributing events.

8. The system of claim 7, wherein each of the probability values for unpopulated locations in the contributor columns is populated with a value of one, and each of the probability values for locations in the contributor columns that map to the occurrence of each of the basic events in each of the rows is populated with a value of one.

9. The system of claim 8, wherein each of the combined probabilities is calculated as a product of each of the probability values across the contributor columns of each of the rows.

10. The system of claim 1, wherein the residual probability for each of the events is output to a report that associates each of the events with an event description and the residual probability for each of the events in a sorted order from a highest residual probability to a lowest residual probability.

11. The system of claim 10, wherein formatting of the report distinguishes values of the residual probability relative to one or more threshold values.

12. The system of claim 1, wherein the tree structure is a fault tree developed by a fault tree analysis tool, the scenario list is a list of cutset scenarios, and the event list and the scenario list are output by the fault tree analysis tool.

13. The system of claim 12, wherein the event list and the scenario list are accessed by one or more applications external to the fault tree analysis tool to build the specific risk matrix and output the residual probability for each of the events.

14. The system of claim 13, wherein the event list and the scenario list are reformatted by a spreadsheet application and imported into a database application to build the specific risk matrix and output the residual probability for each of the events.

15. The system of claim 1, wherein the tree structure comprises an event node for each of the events and an event probability that is based on a failure rate, an exposure time, and a probability type.

16. The system of claim 15, wherein the probability type for each event node having to an average probability is changed to a worst-case probability, and the event probability is updated prior to calculation of the combined probabilities.

17. The system of claim 15, wherein the tree structure is a fault tree structure for a system of an aircraft, and the exposure time is set to a maximum mission flight time for the aircraft.

18. A method for specific risk assessment, the method comprising:
accessing an event list that defines a plurality of events and a scenario list that defines a plurality of scenarios as routes through a tree structure that comprises one or more of the events for each of the scenarios;
building a specific risk matrix that calculates a plurality of combined probabilities based on each pairing of an occurrence of each of the events in combination with each of the scenarios; and
outputting a residual probability for each of the events based on a summation of the combined probabilities for each of the events.

19. The method of claim 18, wherein the events in the event list comprise basic events, and the one or more of the events for each of the scenarios comprise a plurality of contributing events in the scenario list.

20.-34. (canceled)

35. A computer program product for specific risk assessment, the computer program product comprising a computer readable storage medium having program code embodied therewith, the program code readable/executable by a computer, processor or logic circuit to perform a method comprising:
accessing an event list that defines a plurality of events and a scenario list that defines a plurality of scenarios as routes through a tree structure that comprises one or more of the events for each of the scenarios;
building a specific risk matrix that calculates a plurality of combined probabilities based on each pairing of an occurrence of each of the events in combination with each of the scenarios; and
outputting a residual probability for each of the events based on a summation of the combined probabilities for each of the events.

36.-51. (canceled)
